(19) United States
(12) Patent Application Publication
(10) Pub. No.: US 2007/0126603 A1
(43) Pub. Date: Jun. 7, 2007

(54) Method and system for locating parked cars

(76) Inventors: Shon T. Driscoll, Lake Barrington, IL (US); Frank A. Smith, Lake Barrington, IL (US); Rim Yoo, Glendale Heights, IL (US)

Correspondence Address: MOTOROLA, INC., 1303 EAST ALGONQUIN ROAD, IL01/3RD, SCHAUMBURG, IL, 60196, US

(21) Appl. No.: 11/294,954

(22) Filed: Dec. 6, 2005

(51) Int. Cl. G08G 1/123; H04Q 7/20

(52) U.S. Cl. 340/988; 455/456.1

(57) ABSTRACT

A system and a method of determining the location of parked cars in a parking area includes a vehicle-mountable transceiver and a plurality of transceivers disposed throughout the parking area. Each vehicle-mountable transceiver has or is assigned an identification code by which communications between the vehicle-mountable transceiver and the transceivers may be interpreted as a vehicle location. A portable device may also be used, where the portable device may communicate with the vehicle-mountable transceiver and with the transceivers. A server maintains a database having the vehicle identification codes, and the locations of the vehicles and provides vehicle location information to the driver, either in printed form, audible form, or in the form of information transmitted to the portable device.

### TECHNICAL FIELD OF THE INVENTION

This application relates to a method and system of vehicle telematics, and more particularly to the location of parked vehicles in a parking area and the assistance provided to a driver in locating the appropriate vehicle.

### BACKGROUND OF THE INVENTION

When a vehicle has been parked in a parking area for an extended period of time, and the driver thereof has not made a physical record of the parking location, or has forgotten the location of the parking location, a considerable period of time may be wasted by looking through the parking area to locate the desired vehicle. This is particularly true in large parking areas, such as multi-story parking areas in airports, shopping centers, civic centers and the like.

An enclosed parking area presents further difficulties in using position-based location technologies, such as the global positioning system (GPS), which rely on line-of-sight transmission paths between the receiver and the signal source, such as a satellite.

Thus, there is a need for a system to provide assistance to a driver in rapidly locating the desired vehicle without the necessity to either make a physical record of the location in which the vehicle is parked or to remember the information.

### BRIEF DESCRIPTION OF THE DRAWINGS

FIG. 1 illustrates a vehicle-mountable transceiver in a vehicle, in communication with a transceiver;

FIG. 2 is a perspective view of a multi-level parking facility showing typical locations for transceivers and other facilities;

FIG. 3 illustrates portable devices in communication with a vehicle-mountable transceiver in a vehicle;

FIG. 4 is a block diagram of a payment station in communication with a server;

FIG. 5 is an elevation view of a vehicle in two positions on a floor with respect to transceivers;

FIG. 6 is a block diagram of a server; and

FIG. 7 is an example of a data record.

Exemplary embodiments may be better understood with reference to the drawings, but these embodiments are not intended to be of a limiting nature. Like numbered elements in the same or different drawings perform equivalent functions.

### DETAILED DESCRIPTION OF THE INVENTION

Vehicles are being produced having short-range radio transceiving systems using wireless protocols exemplified by protocols such as the Institute of Electrical and Electronics Engineers (IEEE) 802.11a/b/g, the Dedicated Short Range Communications System (DSRC), Bluetooth®, or the like. IEEE 802 is a series of networking and hardware specifications developed and issued by the IEEE. The DSRC is being jointly developed for vehicle safety and other mobile applications by the American Society of Testing and Materials (ASTM) and the IEEE. Bluetooth® (also known as IEEE 802.15.1) is a radio-frequency standard that has been developed by Ericsson (Telefonaktiebolaget LM Ericsson) and maintained by the Bluetooth® Special Interest Group. Such protocols are indicative of the capability that motor vehicles increasingly have for the purposes of communication within the vehicle, between vehicles, between the vehicle and an outside entity, and between a portable device such as a cellular telephone or keyless entry device and the vehicle. Other non-standard or proprietary formats may be used as well, and the use of a specific format, protocol or data set is not necessary in the apparatus, systems and methods described herein.

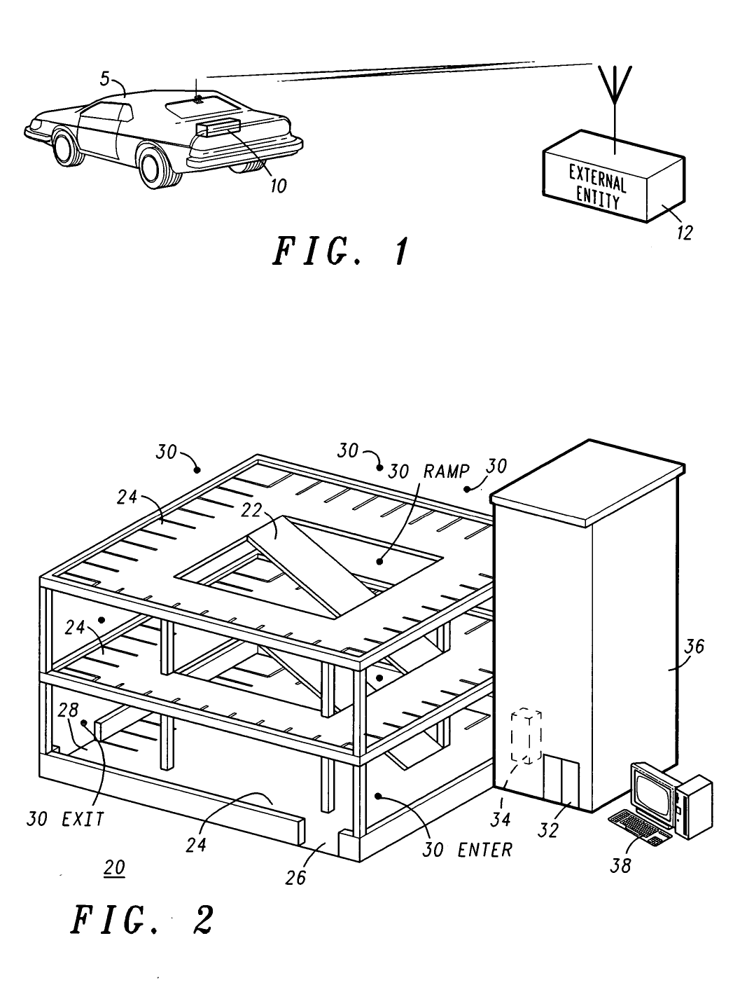

FIG. 1 illustrates a vehicle 5 having a vehicle-mountable transceiver 10, in communication with an external entity 12. The external entity 12 may be a parking area. The vehicle may provide an identification code, which may be either permanent, such as the vehicle identification number (VIN), or ephemeral. Where the identification code is ephemeral, the identification may be associated with each transaction, or with a series of transactions between the vehicle and the device with which communications is being conducted. For ease of explanation, the VIN is used as a representative of all of the potential methods of identifying the vehicle by an identification code, unless otherwise indicated. The term “transceiver” does not preclude the use of only a transmitter or a receiver, as appropriate to perform the function. For example, in a circumstance where the VIN is used, the vehicle 5 may transmit the VIN to a receiver used as a transceiver 30. If there is no need for a transmission between the transceiver 30 and the vehicle 5, then a transmitter portion of the transceiver 30 may be omitted. Whenever the functions of the vehicle location system and method can be performed with transmission of information in one direction only, the use of the term “transceiver” is meant to include only such functionality and apparatus as is necessary, for example, only a receiver or only a transmitter.

FIG. 2 illustrates a multi-story parking area 20, including ramps 22 between the floors 24, an entrance 26, and an exit 28 for use by motor vehicles 5. Pedestrian access and egress may be by a separate portal 32, where an elevator 36 may be provided for convenience or to meet building codes. Pedestrians may exit from the parking area through the vehicle entrance 26 or exit 28, from manual exit doors around the periphery of the ground floor for at least safety reasons, or through the portal 32. In an aspect, the parking facility may include a manual or automatic payment facility 34 located near the portal 32 so that the driver may pay the parking fee and has a ticket validated as an authority to permit exit of the vehicle from the exit 28. The validation of the authority or ticket to exit the parking area may be performed, for example, by one or more of the following: transmitting the authority to a parking gate when the vehicle is known to be in proximity to the exit, by printing or otherwise recording or marking the parking ticket or receipt, or by transmitting the authority to a portable device carried by the user.

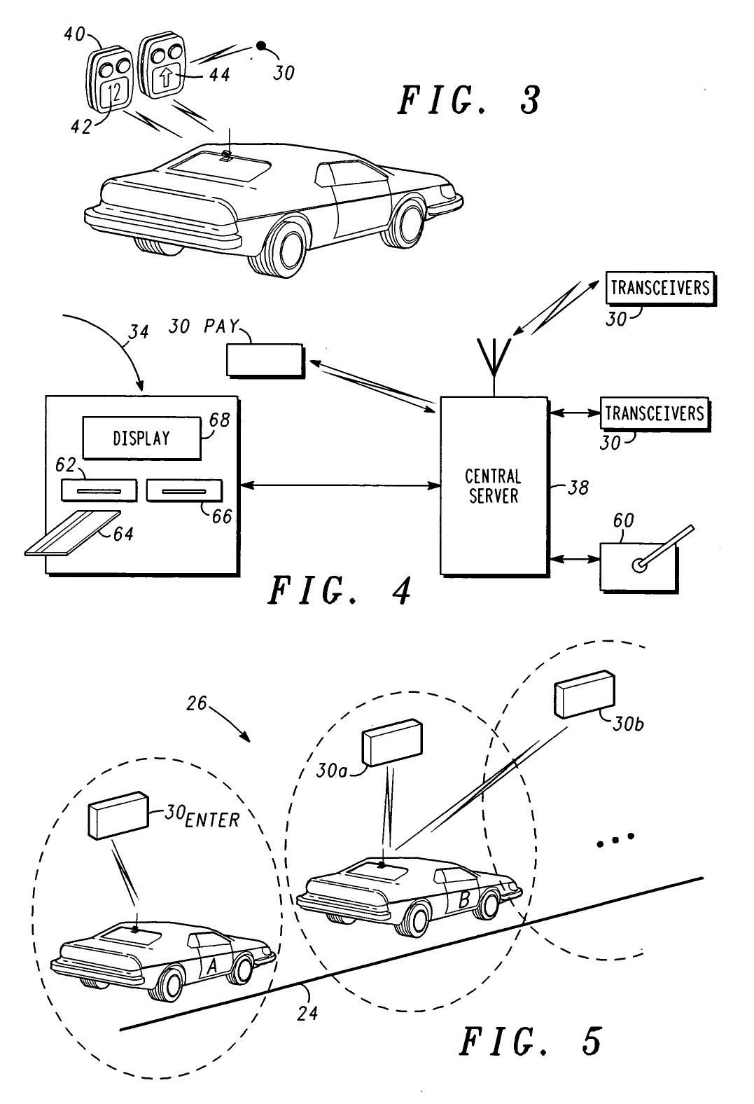

Transceivers 30 may be located at multiple locations within the parking area, and in proximity to the entrance 26, the exit 28, and the payment facility 34 such that communications between a transceiver 30 and the vehicle-mountable transceiver 10 may take place whenever the vehicle 5 is within communications range of a transceiver 30. As illustrated in FIG. 3, a transceiver 30 may also communicate with a portable device 40, which may be a cellular telephone, or other wireless-enabled device, including a vehicle remote entry device or a keyless ignition device; the portable device 40 may also communicate with an aspect of the vehicle 5, such as the vehicle mountable transceiver 10 or another communications device. The transceivers 30 may be located at positions within the parking area such that the vehicle-mounted transceiver 10 is typically in communication with one or more of the transceivers 30 while the vehicle 5 is within the parking area 20. The spacing and location of the transceivers 30 is determined by the layout of the parking area 20, and the particular characteristics of the wireless protocol used. For example, one may select Bluetooth®, with a transmitter power corresponding to a typical range of 10 meters. If a form of signal strength measurement is used to eliminate weak signals, the location of a vehicle 5 may be determined within about 10 meters by transceivers 30 spaced at about 20 meter intervals. Closer spacing of the transceivers 30 may be needed in some directions in the event that there are intervening walls which may tend to limit the propagation of the radio waves. Each of the transceivers 30 is at a known location within the parking area 20, and is in communication with a central server 38, which may be located in any convenient location, either associated with the parking area and facility, or at a distance therefrom and connected to the remainder of the system by a telecommunications network or dedicated communications channel or other communications device. The means of communications between the server and the plurality of transceivers 30 may also include one or more of the wireless protocols previously described, or a variant thereon, a dedicated licensed radio channel, or optical or wired infrastructure.

The central server 38 interfaces with the communications links to the transceivers 30, and may interface with the payment means 38, as shown in FIG. 4. The parking ticket 64 may be read by a ticket reader 66, or the function of the ticket reader may be performed by the card reader 62. The payment means 38 may include one of a card reader 62 accepting either currency or credit cards in payment of the parking fee, or a manual cash register (not shown) where the parking card 64 is read to calculate the parking fee, or receiving a signal from a portable device 40. The parking ticket 64 may be printed with an authorization to exit the parking area 20 by encoding information on a magnetic stripe or any other machine readable medium located thereon, by printing on the parking ticket, or by printing or encoding on a receipt. Although the ticket reader 66 and card reader 64 is shown as if the ticket or card is actually inserted into the device, non-contact reading means, such as radio frequency identification (RFID) may be used.

The instructions for implementing server processes for a client application may be provided on computer-readable storage media or memories, such as a cache, buffer, read only memory (ROM), random access memory (RAM), removable media, hard drive or other computer readable storage media. Computer readable storage media include various types of volatile and nonvolatile storage media. The functions, acts or tasks illustrated in the figures or described herein, whether in the server, the transceivers, the payment means or other apparatus may be executed in response to one or more sets of instructions stored in or on computer readable storage media. The functions, acts, or tasks are independent of the particular type of instruction set, storage media, processor or processing strategy and may be performed by software, hardware, integrated circuits, firmware, microcode and the like, operating alone or in combination. Likewise, processing strategies may include multiprocessing, multitasking, parallel processing and the like. In an embodiment, the instructions may be stored on a removable media device for reading by local or remote systems. In other embodiments, the instructions may be stored in a remote location for transfer through a computer network, a local or wide area network or over telephone lines. In yet other embodiments, the instructions are stored within a given computer or system. Where the use of a computer network is described, the network may be a local network, a wide area network, the Internet, or the like. Communications over a network may be by encoding data onto a carrier, where the carrier may be any one or more of an optical or radio frequency signal or a frequency transmitted on a wire or coaxial cable.

Applications mean any software, firmware or hardware implemented functions communicating directly or indirectly with another application, a client or a server. Such applications may include text messaging, audio or video, e-mail and the like, as well as housekeeping functions such as status reporting. Wireless communication means may include, audio, radio, light wave or any technique not requiring a physical connection between a transmitting device and a corresponding receiving device. A wireless communications device may include both transmitting and receiving functions, or only one of the two functions.

When a vehicle 5 is in proximity to a transceiver 30, the vehicle and the transceiver 30 exchange information so that any transceiver 30 within communications range of the vehicle 5 may obtain a VIN there from. Upon first entering the parking area 20, the vehicle 5 enters into communication with the transceiver 30_{entry} at the entry point 26, and provides a VIN. The transceiver 30_{entry} communicates this information along with the transceiver 30 location, to the central server 38 for registration in a database. By this transaction, the specific vehicle (e.g., a vehicle 5 with VIN #ABC) is recognized as being in the parking area 20. Associated with vehicle ABC may be a portable device 40, which may be, or be incorporated in, one or more of the following: a cellular telephone, a keyless entry device, a personal digital assistant (PDA), or the like. Typically, the portable device 40 is or has been in communication with the vehicle having a VIN identification code ABC. Each portable device 40 may have a permanent or temporary identification code and this identification code may be stored at the vehicle-mountable transceiver 10, and may be transmitted to the transceiver 30 along with the vehicle identification code. Alternatively, the portable device 40 may have a fixed identification code which has been previously associated with the vehicle 5, and is known to, or stored in, the vehicle-mountable transceiver 10. For this example, the vehicle ABC has an associated portable device 40 having an identification code abc.

As will be evident, the system need not have portable devices 40, however, in this example, one or more of the vehicles 5 has an associated portable device 40, usually associated with the driver or an occupant of the vehicle. The identification number of the portable device 40, if any, associated with the vehicle 5 is registered along with the vehicle VIN in a database of the server 38. The vehicle-mountable transceiver 10, the fixed transceivers 30 and the portable device 40 may all use the same wireless data protocol, however, this is not required, as communications between the vehicle-mountable transceiver 10 and the fixed transceivers 30, between the vehicle-mountable transceiver 10 and the portable device 40, and between the server 38 and the portable device 40 may occur by different protocols. If a different wireless data protocol is used for one or more of the functions, transceivers compatible with these protocols are suitably disposed. Communications between the server 38 and the portable device 40 may occur by one or more wireless protocols, so that connectivity between the server 38 and the portable device 40 may occur for a variety of equipment types and manufacturers. Similarly, the transceivers 30 may support more than one wireless protocol for compatibility with vehicle-mountable transceiver 10 wireless protocol characteristics.

For each vehicle 5 entering the parking area, the VIN ABC is stored in the server and a portable device 40 identification code abc is associated therewith, if available. As the vehicle 5 is driven within the parking area 20, the vehicle 5 moves with respect to the plurality of transceivers 30. For this example, the transceiver 30 at the vehicle entry area 26 has been designated 30_{entry}. Similarly, the transceiver at the vehicle exit area has been designated 30ₑₓᵢₜ, and the transceiver at the payment area 34 has been designated 30_{pay}.

FIG. 5 is a plan view of a typical parking area floor, showing transceivers 30_{entry}, and transceivers 30 a, b of the plurality of transceivers 30, with respect to a vehicle 5 in positions A and B. Shown by a dashed line is an estimated or a measured communications range from each of the fixed transceivers 30 for the wireless communication protocol selected. Although the communications range between a transceiver 30 and the vehicle-mountable transceiver 10 is discussed as if the communications range in an uplink or downlink direction is the same, there may be circumstances where this is not the case, either by design or circumstance. Amongst the factors which will influence the communications range in each direction are: transmitter power, received signal strength threshold, data rate, radio noise level, antenna directionality and the like.

As the vehicle 5 moves on the floor 24 of the parking area, as the driver looks for a vacant parking location, the vehicle-mountable transceiver 10 in the vehicle 5 establishes communications between the vehicle-mountable transceiver 10 and one or more of the fixed transceivers 30. As an example, the vehicle 5 is in position A, communications is established with transceiver 30_{entry}, but with no other transceiver 30; when the vehicle 5 is in position B, communications is established with transceivers 30 a, b, while communications with transceiver 30_{entry} is no longer possible. Thus, the vehicle 5 is localized with respect to the transceivers 30 which are presently in communication with the vehicle-mountable transceiver 10. As communications is established or lost between transceivers 30 and the vehicle-mountable transceiver 10 associated with vehicle 5 having an identification code ABC, the status of the communications is reported to the server 38 by the transceivers 30. As the vehicle 5 moves along the floor 24 of the parking area 20, the sequence of status reports serves to localize the vehicle 5 with respect to the transceivers 30, and hence, with respect to a physical location on the floor. Each transceiver 30 may be associated with an approximate area on the floor 24 where the vehicle 5 is presently located. For presentation to a human, this information may be converted into a sequence of parking space numbers 1-N, or to a general floor area, such as 2N, 2S, 2E, 2W, representing marked areas on a floor plan or on pillars, walls or floors.

Transceivers 30ᵣₐₘₚ may be located at ramps 22 where the vehicle 5 can move between floors, in order to maintain continuous tracking coverage, however, intermittent interruptions in the communications between the vehicle 5 and the transceivers 30 may occur without compromising the performance of the system and method, as the location of the vehicle 5 is reported as the last known position. A similar situation occurs if the vehicle-mounted transceiver 10 in the vehicle 5 is shut off when the vehicle 5 has been parked, and the engine stopped, so as to conserve battery power. Even when the vehicle-mountable transceiver 10 in the vehicle 5 remains operative when the vehicle 5 is parked, the position of the vehicle 5 as reported is equally representative of the parked location of the vehicle 5.

When the operator returns to the vehicle 5, and drives the vehicle 5 to either another location in the parking area 20, or exits the parking area at the exit 28, the communications between the transceivers 30 and the vehicle-mountable transceiver 10 in the vehicle 5 may be used to continue to track the movement of the vehicle 5. In the case of a vehicle which has been re-parked, the new parking location can be determined by analysis of the database entries representing status reports from the transceivers 30. In the situation where the vehicle 5 exits the parking area 20 through the exit 28, the communications at transceiver 30ₑₓᵢₜ is reported to the server 38, and the vehicle 5, having identification code ABC may be deleted from the database in the server 38, or marked as having left the parking area 20.

For convenience in explaining this example, the correspondence between a transceiver 30ₙ and a specific physical location area is presumed, and the conversion to a designation such as a parking space number or an floor and designation letter understood to be an alternative form of representation of the data for display or printing such that it may be conveniently interpreted by the driver of the vehicle. Additional physical locations may be associated with pairs or groups of transceivers 30. Typically, such a location is intermediate between the physical locations of adjacent transceivers 30.

When the driver, or other person in possession of the portable device 40 reaches the vicinity of the payment area 34, such as by entry through a portal 32, the portable device 40 may come within range of a transceiver 30ₚₒᵣₜₐₗ located in the vicinity thereof. The location of the vehicle 5 associated with the specific portable device 40, having an identification code abc, with a corresponding vehicle code ABC is retrieved from the database in the server 38 and transmitted by the transceiver 30ₚₒᵣₜₐₗ to the portable device 40. The information may be displayed on a suitable display 42 as alphanumeric information, recited by a voice synthesizer (not shown), or the like. Alternatively, if a printed ticket 64 is used as a transaction document, the location may be printed on the ticket 64 by a printer 66 associated with the payment receiving device 38. The information may be displayed either before or after payment has been made.

In another alternative, the portal 32 may be only an entrance to the parking area 20, and payment made at another point, such as the exit 28, in which instance, the transceiver 30ₚₒᵣₜₐₗ provides the vehicle 5 location without the necessity for payment of the parking fee. In yet another alternative, when payment is made at the payment area 34, the vehicle location is transmitted from the transceiver 30ₚₒᵣₜₐₗ to the portable device 40. An authorization to permit the vehicle 5 may then be communicated to the transceiver 30ₑₓᵢₜ, and may additionally be communicated to the transceivers 30 in the vicinity of the known vehicle location. This may permit a paperless transaction to occur, wherein the vehicle may be permitted to exit the parking area 20 after payment of the parking fee.

In a further alternative, the portable device 40 may have the capability of authorizing payment of the parking fee, the parking fee being paid either at the payment area 34, or at the parking exit 28. The vehicle-mountable transceiver 10 may also have such a capability and perform the function when the vehicle is in the vicinity of the exit transceiver 30ₑₓᵢₜ.

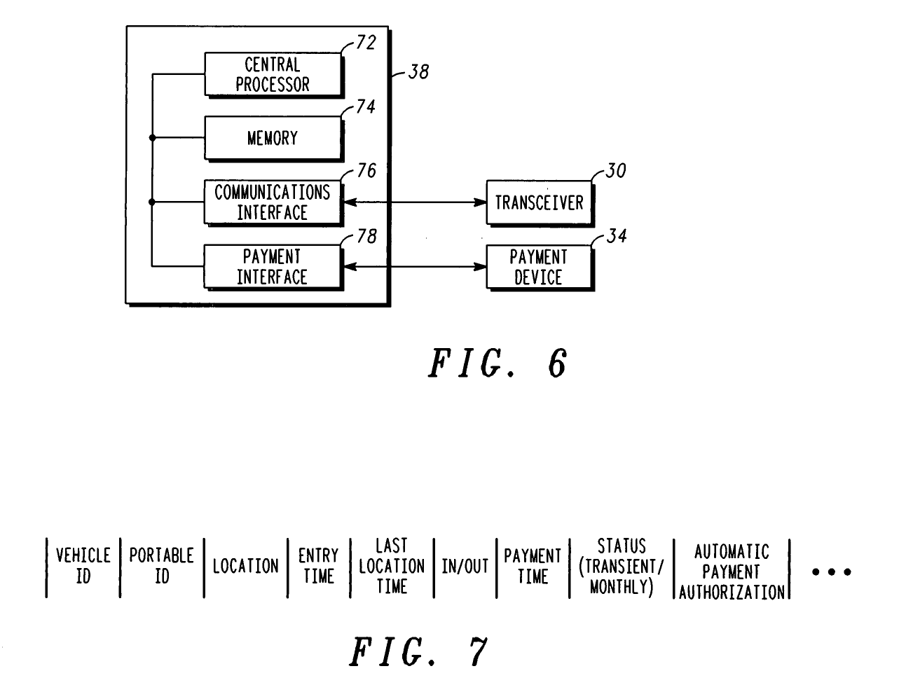

The server 38, shown in FIG. 6 may have a computing system including a central processor 72, memory 74 and communications interfaces 76 to the various transceivers 30, and may have interfaces 78 with the payment means, and with payment authorization means, as well as a controller for the exit gate (not shown).

A database for vehicles may be maintained by an application program executing on the server 38. The database may be of any suitable type as is known in the art, and have a data structure adapted to the requirements of the customer and the installation design. In an aspect, a vehicle database may include data fields such as shown in FIG. 7, and may include, vehicle ID, associated portable computer ID, time of entry, time of last location determination, last location, last location in human readable format, payment status, payment time, exit authorized, and the like.

For each of the vehicles 5 having a vehicle-mountable transceiver 10 in communication with a transceiver 30, the transceiver 30 reports the presence of a communication and the time of occurrence. Many wireless protocols are capable of substantially simultaneous communication with a plurality of other similarly capable devices, however, in some wireless protocols, communication with a plurality of devices takes place in a time sequential manner. Since the number of vehicles 5 in proximity to a transceiver 30 is limited by the range of communications and by the density of vehicles which can occupy a floor space within the range of communications, it may be sufficient to consider communications occurring, for example, within a several second period as being representative of the position of the vehicle 5, having an identification code ABC.

An applications program relates the status reports of communications between a vehicle 5, having an identification code, and the plurality of transceivers 30 to a physical area of the parking area, or to one or more parking space designators such as a parking space number or a range of parking space numbers. In one aspect, the all of the transceivers 30 reporting communications with a vehicle 5 having a specific identification code, and occurring within a time window T are considered. The time window T may be, for example, one second. Each transceiver 30, or groups of transceivers 30, may be associated with a location of the vehicle 5. As shown in FIG. 5, in state A when the vehicle is close to one transceiver 30_{entry}, the report of communications comes only from transceiver 30_{entry}, whereas in state B, when the vehicle 5 is approximately equidistant from transceivers 30 a and 30 b, and much further from transceiver 30_{entry}, the report of communications with the vehicle may be only from transceivers 30 a and 30 b, with no report from transceiver 30_{entry}. As the vehicle 5 moves along a path through the parking area 20 to a parking spot, the latest position information is updated in the associated database record. After finding a parking location, the driver positions the vehicle 5 in the parking space and turns off the ignition. Turning off the ignition means that the driver has, in some manner, turned off the engine or otherwise immobilized the vehicle 5 such that it cannot be moved except by an authorized person. In this state, the vehicle-mountable transceiver 10 may either enter a dormant state, or otherwise indicate the status to the transceivers 30 with which the vehicle-mountable transceiver 10 is in communication. In this parked state, the server records the present position of the vehicle as the parked location. The last known location of the vehicle 5 may be interpreted as the parked location.

Other algorithms may equivalently be used to interpret the communications between a vehicle-mountable transceiver 10 and one or more transceivers 30 in order to determine the vehicle location.

The vehicle parked location, along with other data such as vehicle identification code, the associated identification code and the characteristics of any associated portable device 40 may be stored.

When a portable device 40 comes within communications range of any of the fixed transceivers 30, communications may be established with the portable device 40, providing that both the portable device 40 and the transceiver 30 have compatible wireless protocols. Not all of the transceivers 30 may be equipped with compatible wireless protocols. However, if aiding of the driver by providing vehicle location by wireless means is desired, at least one of the transceivers 30 or an auxiliary transceiver (not shown) should have such a compatible protocol, and may be located near the payment point 34 or entry portal 32. Absent communications between the portable device 40 and the transceivers 30, the payment means 34 may display the location of the car on a display 68 when payment is rendered, or may print the location on a parking receipt by either the ticket reader 62, or a separate printer 66.

In an example where communications is possible between a portable device 40 and the transceivers 30, further guidance may be provided to the driver. The location of the portable device 40 with respect to the plurality of transceivers 30 may be determined in a manner analogous to that previously described to locating a vehicle 5. A location pair consisting of the vehicle 5 with a specific vehicle identification code, such as ABC, and a portable device 40 having a specific identification code such as abc, which has previously been associated with the vehicle having an identification code ABC is a basis for providing detailed guidance to the driver as to the best route to the vehicle 5.

The location of the vehicle 5 in a specific parking space is fixed during the retrieval period, and the location of the portable device 40 may change due to the motion of the person carrying the portable device 40. Any of a variety of routing algorithms, as are known in the art, may be used to provide directions as to the most expeditious route between the current location of the person and the associated vehicle 5, and a new route may be determined whenever the position of the portable device 40 has changed.

Many portable devices 40 used for vehicle entry and for ignition control are fitted with “panic” buttons to be used in an emergency. Ordinarily, such a portable device 40 is in communications with the vehicle 5 and activates an alarm. When walking in a parking area, however, the person may be too far from the vehicle for the panic button to activate the alarm. But, if the portable device 40 is in communication with a transceiver 30, or an auxiliary transceiver, such a panic alert may be transmitted to the parking area security function along with the location of the person.

The function of the transceivers 30 and the vehicle-mountable transceivers 10 have been described as if establishing the location of the vehicle is their only function. Other services may be provided by this system, such as updating databases in a vehicle, providing alarms if the vehicle is moved without the proper authority, and the like. Such vehicular databases may range from road maps to traffic information, to web based services including video, audio, and the like. Updates may be made while the vehicle is stationary, and by high-bandwidth short-range links, so that bandwidth demands on highway communications infrastructure may be reduced.

In an example, a method of providing location assistance to a driver in a parking area includes: establishing communications between a vehicle-mountable transceiver located in a vehicle and one or more transceivers; determining the position of the vehicle by analyzing the status reports from the transceivers, and associating the position of the vehicle with a vehicle identification code; storing the location of the vehicle when the vehicle has been parked; providing the parked location of the vehicle to the driver.

The method of providing the parked location of the vehicle to the driver may include one or more of: printing the location of the parked vehicle on the receipt issued to the driver when the parking fee has been paid; displaying the location of the parked vehicle on a display visible to the driver when the parking fee has been paid; communicating with a portable device having an identification code associated with the vehicle identification code, or transmitting the location of the vehicle to the portable device.

The method of transmitting the location of the vehicle to the portable device may include one or more of: converting the parked vehicle location into a representation corresponding to physical signage, such as a parking space number or a geographical designator, transmitting the representation to the portable device, and displaying the representation at the portable device; determining the location of the portable device and, using the known position of the parked vehicle, transmitting routing instructions to the portable device.

A wide variety of other related service may be provided with this system and method, including locating the vehicle for service personnel so as to permit servicing the vehicle when the driver is not present, determining the location of the vehicle when re-parking the vehicle after servicing in another parking location, or the like. The system and method may also permit monthly or other contract parking participants to enter and leave the parking area without traversing the paying location 32 and without a separate magnetic card or transceiver.

The system and method may be used with any and all vehicles having the appropriate wireless communications capability. The system and method in a parking area may operate on a permissive basis. That is, there services described herein are provided to the drivers to the extent that suitable equipment associated with the vehicle, such as a vehicle-mounted transceiver, and ancillary equipment such as a portable device are available, and to the extent that the capabilities are supported by the equipment installed at the parking area. Absent such capabilities, the vehicle may use the facilities without the additional features described herein.

It is therefore intended that the foregoing description be regarded as illustrative rather than limiting, and that it be understood that it is the following claims, including all equivalents, that are intended to define the spirit and scope of this invention.

What is claimed is:

1. A vehicle location and reporting system, comprising:
a plurality of transceivers;
a server in communications with the plurality of transceivers, configured to determine the physical location of a vehicle-mountable transceiver.

2. The system according to claim 1, wherein the vehicle-mountable transceiver has a unique identification code.

3. The system according to claim 2, wherein the unique identification code is assigned by the server.

4. The system according to claim 1, further comprising a portable device, having an identification code associated with the vehicle-mountable transceiver identification code.

5. The system according to claim 1, wherein a portable device identification code and a vehicle-mountable transceiver identification code are associated with a vehicle-mountable transceiver location and stored in a server database.

6. The system according to claim 1, wherein the location of the vehicle-mountable transceiver is output by at least one of printing, an audio synthesizer, or transmitting the location to a portable device.

7. A method of locating vehicles, the method comprising:
communicating between one or more of a plurality of transceivers and a vehicle-mountable transceiver;
determining the location of the vehicle-mountable transceiver; and
storing the vehicle-mountable transceiver location and a vehicle identification code.

8. The method of claim 7, wherein associating at least one of a fixed or ephemeral identification code with the vehicle-mountable transceiver.

9. The method of claim 8, further comprising assigning the ephemeral identification code to the vehicle-mountable transceiver in response to a first communication between the vehicle-mountable transceiver and one of the plurality of transceivers.

10. The method of claim 9, wherein the ephemeral vehicle identification code is assigned by a server in communications with the plurality of transceivers.

11. The method of claim 7, wherein the vehicle-mountable transceiver location is stored in a server.

12. The method of claim 7, wherein the providing the vehicle-mountable transceiver location to a user further comprises:
providing an entry ticket to the user;
associating an identification code of the entry ticket with the vehicle identification code, and storing the association in a server;
reading the entry ticket identification code at a payment station;
retrieving a vehicle-mountable transceiver location corresponding to the vehicle identification code; and
at least one of:
printing the vehicle-mountable transceiver location on the entry ticket;
reciting the vehicle-mountable transceiver location using a voice synthesizer; or
displaying the vehicle-mountable transceiver location.

13. The method of claim 7, wherein the providing the vehicle-mountable transceiver location to a user further comprises:
associating a portable device with the vehicle identification code, and storing the association in a server;
communicating with the portable device having the associated identification code; and
transmitting a vehicle-mounted transceiver location from at least one of the plurality of transceivers to the portable device.

14. The method of claim 13, further comprising:
establishing the location of the portable device having the associated identification code; and
determining a route between the portable device location and the vehicle-mountable transceiver location and transmitting route information to the portable device.

15. The method of claim 7, wherein a payment for use of the parking area is authorized by a portable device.

16. The method of claim 7, wherein the egress of a vehicle from the parking area is authorized by one of:
determining that a payment for use of the parking area has been made, or a value stored in the server and associated with the vehicle identification code indicating that a parking fee payment has been received.

17. The method of claim 7, wherein the egress of a vehicle from the parking area is authorized, providing that a credit facility has been established and associated with a vehicle identification code.

18. A method of locating vehicles, the method comprising:
associating an identification code with a portable device;
associating the portable device identification code with a vehicle-mountable transceiver identification code; and
providing the location of the vehicle-mountable transceiver to the portable device having the portable device identification code associated with the vehicle-mounted transceiver identification code.

19. The method of claim 18, further comprising:
providing a route between a location of the portable device and the location of the vehicle-mounted transceiver.
